(19) United States
(12) Patent Application Publication
(10) Pub. No.: US 2010/0145519 A1
(43) Pub. Date: Jun. 10, 2010

(54) INDUSTRIAL ROBOT AND METHOD TO OPERATE AN INDUSTRIAL ROBOT

(76) Inventors: Hartmut Keyl, Augsburg (DE); Gernot Nitz, Augsburg (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/633,876

(22) Filed: Dec. 9, 2009

(30) Foreign Application Priority Data
Dec. 10, 2008 (DE) 10 2008 054 501.5

(51) Int. Cl. G05B 15/00; H02P 6/16

(52) U.S. Cl. 700/258; 318/490

(57) ABSTRACT

In an industrial robot and a method for operating an industrial robot, a robot arm is pivotable with respect to multiple axes. At least one of the axes has an drive associated therewith for controlling movement of the robot arm with respect to that axis. The electrical drive includes a three-phase synchronous motor that is operated with associated electrical currents and electrical voltages. A signal representing at least one of said electrical currents and electrical voltages is supplied to a computerized control unit that determines, from the signal, the position of the axis associated with the electrical drive. The computerized control unit controls operation of the electrical drive dependent on this determined position.

### BACKGROUND OF THE INVENTION

1. Field of the Invention

The present invention concerns an industrial robot and a method to operate an industrial robot.

2. Description of the Prior Art

Industrial robots are manipulation machines that are equipped for automatic manipulation of objects with appropriate tools and can be programmed in multiple movement axes, in particular with regard to orientation, position and workflow. Industrial robots essentially have a robot arm with multiple axes and arms that are moved by drives. The drives are, for example, electrical drives that can be operated by synchronous motors.

For the operation of the industrial robot, it is necessary to register the positions of the movement axes, for example their angle positions, in particular in a reliable technique.

For a reliable position detection, in particular of position-controlled electrical drives, the position (in particular the angle position of the rotor of the electrical motor of the drive) can be determined by means of a resolver. Based on its relatively low failure rate demonstrated in operation over decades, position detection by means of a resolver is presumed to be reliable, although basically two independent ways for the position detection do not exist.

Resolvers are cost-effective and therefore relatively widespread. Resolvers possess a relatively limited resolution, however, and have relatively large angle errors, typically in the range of a few angular minutes.

An additional possibility to determine the position of the rotor (and thus the position of the relevant movement axis) is by the use of known sin/cos sensors or incremental sensors (generally “rotary encoders”), for example with optical or magnetic detection. With rotary encoders, resolutions of greater than 20 bits per rotation at precisions of better than 10″ are technically possible. Relatively highly dynamic and highly precise position-controlled drives can thereby be realized.

In contrast to resolvers, rotary encoders are considered unreliable, which is why a second, redundant position detection system is required given the use of rotary encoders. For example, this can be a second rotary encoder, or a resolver. However, rotary encoders are relatively expensive, in particular in comparison to resolvers.

### SUMMARY OF THE INVENTION

An object of the present invention is to provide a cost-effective, reliable and (if necessary) also precise position detection of a movement axis of an industrial robot.

This object is achieved in accordance with the invention by an industrial robot having a robot arm with multiple axes, at least one electrical drive that has three-phase synchronous motor and that moves one of the axes, and a position detection device that is configured to determine the position of the axis associated with the synchronous motor, by means of signals that are associated with electrical currents and/or electrical voltages of the synchronous motor.

The object of the invention is also achieved by a method for operation of an industrial robot, which includes the following method steps:
determine, with a position detection device, the position of one axis of an industrial robot possessing multiple axes,
determine the position of the axis by means of signals that are associated with electrical currents and/or electrical voltages of a three-phase synchronous motor moving the axis.

The industrial robot according to the invention has a robot arm with multiple axes that, as is generally known, can be moved by means of (for example) drives, in particular by means of electrical drives. According to the invention, one of the axes moves by means of an electrical drive embodying a three-phase synchronous motor. The synchronous motor is advantageously a permanently energized synchronous motor, but this does not necessarily need to be the case.

In order to determine the position of the axis associated with the synchronous motor, the industrial robot according to the invention has a position detection device (which is advantageously a rotary encoder, for example a sin/cos sensor or an incremental sensor). Other position detection devices are also possible in principle, for example a resolver.

In addition, the industrial robot according to the invention is configured to determine the position of the axis associated with the synchronous motor by means of the signals. The signals are associated with the electrical currents and/or electrical voltages of the synchronous motor. The signals possibly provide for a regulation (in particular for a current regulation) of the synchronous motor or of the electrical drive embodying the synchronous motor, so the use of the signals for position determination can be realized in a relatively cost-effective manner.

The signals can also be associated with additionally generated electrical currents and/or electrical voltages serving for the movement of the three-phase synchronous motor. Namely, relatively short-term external pulses can be pulsed on the motor windings which exhibit known input properties and induce different output pulses depending on the rotor position of three possible coils of the three-phase synchronous motor, which output pulses can be detected and evaluated such that the rotor angle position can be derived from these.

The position of the relevant axis is the angle position of the axis relative to a reference angle and/or is the position (in particular the angle position) of the rotor of the synchronous motor.

According to one embodiment of the industrial robot or of the method according to the invention, the first signals are associated with the three-phase electrical voltages and/or the three-phase electrical currents. In practice it is not necessary to determine all three voltages or currents of the synchronous motor. It is only necessary to measure two of the three-phase voltages or of the three-phase currents. The third variable can then be determined from the two other values based on known relationships of three-phase current engineering. Conclusions as to the angle position of the rotor of the synchronous motor (and thus of the position of the corresponding axis) can be made by means of the determined electrical currents or voltages.

The electrical drive embodying the synchronous motor can have a converter upstream of the synchronous motor, with an intermediate circuit whose intermediate circuit voltage is associated with the signals. Such converters as such are known to the man skilled in the art. These generate (for example by means of pulse width modulation) an adjustable three-phase voltage for the synchronous motor and include the intermediate circuit that, for example, has an accordingly dimensioned capacitor.

The position of the relevant axis that is determined by means of the signals can be expressed in mechanical (or in electrical) angle degrees of the rotor of the synchronous motor.

The industrial robot according to the invention can have a control device that is configured to activate the drive for the movement of its axis. This control device can also be configured to evaluate the positions determined by means of the signals and the positions determined by the position detection device and to stop the movement of the relevant axis or all axes of the industrial robot according to the invention in the event that the two determined positions differ by a predetermined value. It is thus possible to mutually monitor the two position determinations.

In a preferred embodiment of the industrial robot according to the invention, the aforementioned signals are first signals and the robot is configured for the movement of the axis associated with the synchronous motor to regulate the drive based on second signals originating from the position detection device. The axes or their drives are normally regulated. The drives are regulated or position-regulated dependent on rotation speed. According to this variant, the information about the angle positions of the relevant axes that is necessary for such a regulation is determined by the position detection device. In particular, a relatively precise position determination (in particular angle determination of the rotor) that has a positive influence on the regulation of the drive embodying the synchronous motor can ensue when rotation sensors (for example sin/cos sensors or incremental sensors) are used as the position detection device. Requirements for a relatively high-quality regulation of this drive (and thus of the relevant axis) are thereby provided.

The position determination by means of the first signals is then used for additional monitoring of this axis, whereby a requirement for a certain position monitoring is provided.

Depending on the embodiment of the industrial robot according to the invention, requirements for a cost-effective, highly precise and highly dynamic position-regulated electrical drive for the relevant axis of the industrial robot thus arise due to the use of a relatively precise and relatively dynamic position detection, in particular by means of rotation sensors or another position detection system.

According to the invention, the redundant position detection by means of a “sensorless” position detection based on the signals is realized for the reliable position monitoring. In this context, “sensorless” means that no additional sensors are necessary outside of the sensors that are possibly already present (for example for a current regulation of the drive) in the converter that is possibly present. “Sensorless” position detections are disclosed in, for example, EP 1 051 801 B1, DE 102 26 974 A1, DE 10 2006 004 034 A1, EP 0 539 401 B1, DE 10 2007 003 874 A1 or EP 0 579 694 B1.

One advantage of the industrial robot according to the invention or, respectively, of the method according to the invention can be that a completely redundant second way of position detection is achieved without additional costs (or, respectively, only slight costs if there are any) since the “sensorless” position detection by means of the first signals can be realized completely via software in the converter that is possibly present, using current and voltage measurement devices that are possibly already present.

The “sensorless” system is used for the redundant detection of the position of a regulated electrical drive for the relevant axis of the industrial robot, which regulated electrical drive possesses a synchronous motor, in particular a permanently energized synchronous motor. According to the invention, the fact can also be utilized that the regulation of such an electrical drive is generally realized via what is known as a field-oriented regulation (“vector control”) that requires for operation the three phase currents (at least two of the three phase currents; the third phase current can be calculated) and possibly the intermediate circuit voltage of the converter. These sensors that are already present are sufficient to conclude the rotor position of the synchronous motor via the algorithms known from the aforementioned printed documents, for example. Two independent ways are therefore provided for position detection according to the invention:

1st way: Conventional position detection via, for example, rotary encoders (in general: position detection device). Depending on the embodiment of the industrial robot according to the invention or, respectively, of the method according to the invention, the position regulation and the current regulation of the electrical drive possessing the synchronous motor herewith run based on the possibly higher resolution, the possibly higher precision and the possibly better dynamic properties.

2nd way: “Sensorless” detection by means of the first signals: the position of the relevant axis determined by means of the position detection device is hereby possibly monitored or observed.

The industrial robot according to the invention thus allows a highly dynamic, highly precise and cost-effective system with certain position detection.

### BRIEF DESCRIPTION OF THE DRAWINGS

FIG. 1 illustrates an industrial robot.

FIG. 2 illustrates an electrical drive of the industrial robot shown in the manner of a block diagram.

### DESCRIPTION OF THE PREFERRED EMBODIMENTS

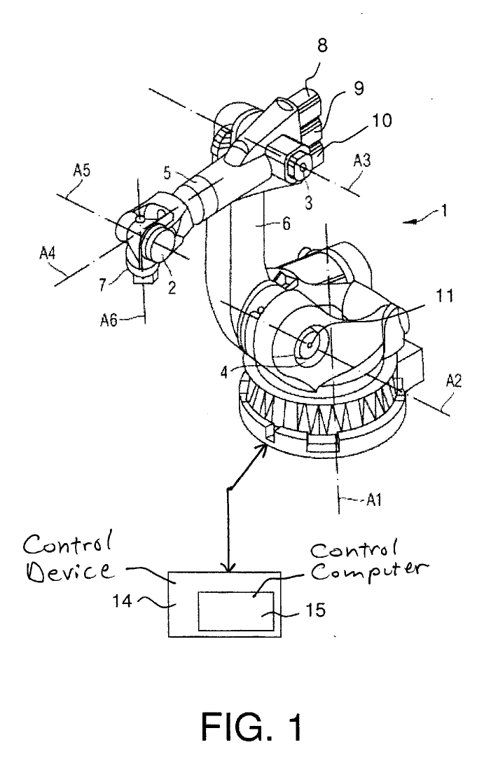

FIG. 1 shows an industrial robot 1 with kinematics for movements in six degrees of freedom. The industrial robot 1 has in a generally known manner, joints 2 through 5, arm 6, six movement axes A1 through A6 and a flange 7.

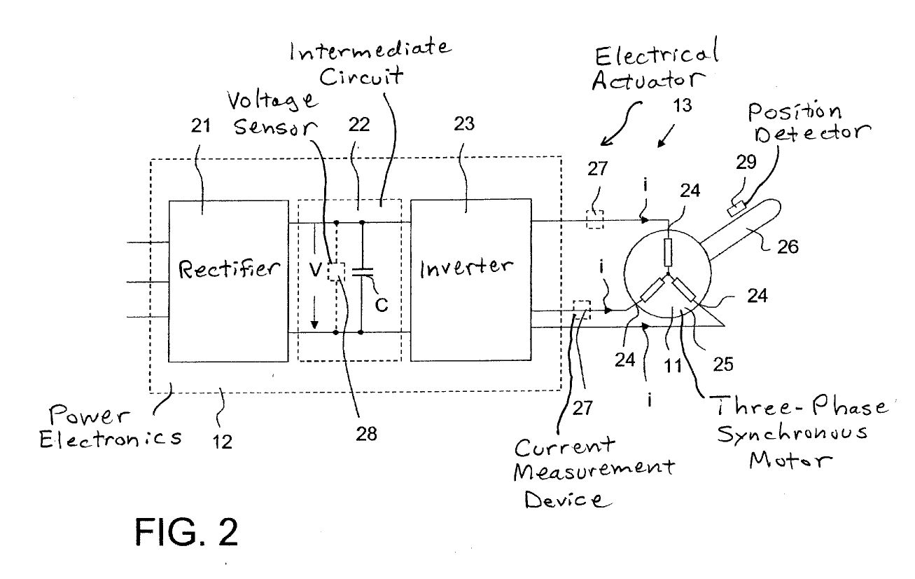

Each of the axes A1-A6 is moved by an drive 13, all of which, in the case of the present exemplary embodiment, are electrical drives and each has a motor 8-11. For example, the motor 11 or the corresponding electrical drive 13 that is shown in FIG. 2 moves the axis A2, possibly by means of a transmission gearbox (not shown in detail but generally known to those skilled in the art).

In the exemplary embodiment, the electrical motors 8-11 are three-phase synchronous motors, in particular permanently energized synchronous motors. The motors 8-11 are each activated by power electronics 12 (what are known as converters) that, in the exemplary embodiment, are arranged in a control device 14. Each power electronics 12 is electrically connected with one of the electrical motors 8-11. One of the power electronics 12 for the motor 11 is shown as an example in the manner of a block diagram in FIG. 2. The electrical drive 13 moving the axis A2 thus includes the motor 11 and the power electronics 12.

The electrical drives 13, or the power electronics 12 of the electrical motor 11 as well as the remaining electrical drives, are connected with a control computer 15 of the control device 14 on which a suitable computer program runs that is known in principle to those skilled in the art. The program activates the power electronics 12 in a suitable and generally known manner so that the industrial robot 1 moves as desired. In the exemplary embodiment, the control computer 15 is arranged with the power electronics in the housing of the control device 14.

In the exemplary embodiment, each of the power electronics 12 for the electrical motors 8-11 has a rectifier 21, an intermediate circuit 22 and an inverter 23. The intermediate circuit 22 has a capacitor C, and from the three-phase mains current the rectifier generates (in a generally known manner) a direct voltage V smoothed by the capacitor C of the intermediate circuit 22. The smoothed direct voltage V is the input voltage of the inverter V, which generates from the direct voltage V (in a generally known manner) a three-phase voltage with adjustable frequency of its fundamental oscillation. The three-phase voltage is supplied to the motor terminals 24 of the motor 11 and is generated by pulse width modulation (PWM), for example.

However, it is also possible for the motors 8-11 to split a rectifier and an intermediate circuit, and an inverter connected with the single intermediate circuit is respectively associated with each of the motors 8-11.

In the exemplary embodiment, the inverter 23 has in a generally known manner, half bridges (not shown in detail in the Figures) that respectively has three semiconductor switches with associated recovery diodes. In the case of the present exemplary embodiment, the semiconductor switches are power transistors (for example, are IGBTs).

The motor 11 has, in a generally known manner, a stator 25 and a rotor 26 whose rotation speed depends on the frequency of the fundamental oscillation generated by the inverter 23.

In the exemplary embodiment, the electrical drive 13 and the remaining drives are regulated in terms of rotation speed, using the vector control familiar to those skilled in the art. For the regulation of necessary signals, for example the electrical currents i and the electrical voltages of the motor 11, measurements are made via suitable measurement devices and supplied to the control computer 15 on which the computer program runs that is provided for regulation of the drives 13.

In the present exemplary embodiment, only two of the three electrical currents i of the motor 11 are determined by means of current measurement devices 27. The third current i of the motor 11 determines the control computer 15 in a generally known manner from the two remaining currents i. The control computer 15 determines the three-phase voltage of the motor 11 from the direct voltage V of the intermediate circuit 22 and the switch positions of the semiconductor switches of the inverter 23, as is in principle familiar to the man skilled in the art. The direct voltage V of the intermediate circuit 22 is measured by a voltage sensor 28 that is connected (in a manner not shown) with the control computer 15.

In the exemplary embodiment, the industrial robot 1 has one rotary encoder for each of its axes A1-A6, of which the rotary encoder 29 of the axis A2 is shown in FIG. 2. The rotary encoder 29 (which is, for example, a sin/cos sensor or an incremental sensor) is connected (the manner is not shown) with the control computer 15 so that this can evaluate signals originating from the rotary encoders. The signals originating from the rotary encoder 29 are a measure of the position of the rotor 26 of the motor 11 associated with the axis A2, and thus is a measure of the position (in particular the angle position or angle setting) of the axis A2.

In the case of the present exemplary embodiment, information about the angle position of the rotor 26 and the axis A2 as well as the remaining axes A1, A3-A6 is thus provided to the control computer 15. The angle position of the axis 2 or of the rotor 26 of the motor 11, which is determined with the rotary encoder 29, is used for the regulation of the electrical drive 13.

In the exemplary embodiment, the control computer 15 evaluates the information about the positions of the axes A1-A6 based on the signals originating from the corresponding rotary encoders 29 in order to detect a possible emergency situation, and possibly to control the drives 13 such that a current movement of the industrial robot 1 is braked.

For a reliable monitoring of the positions of the axes A1-A6, in the present exemplary embodiment these positions are additionally monitored or determined in a further embodiment of the method. For this purpose, the control computer 15 evaluates the signals associated with the electrical currents i of the motors 8-11 and the direct voltages V of the intermediate circuits 22 in order to conclude the angle positions of the rotors 26 of the relevant motors 8-11. Algorithms by which the angle positions of rotors of synchronous motors can be concluded based on the measured electrical currents and/or voltages are known in principle to those skilled in the art (for example from the printed documents cited in the preamble: EP 1 051 801 B1, DE 102 26974 A1, DE 10 2006 004 034 A1, EP 0 539 401 B1, DE 10 2007 003 874 A1 or EP 0 579 694 B1) and are therefore not explained in detail.

In the exemplary embodiment, the control computer 15 is set up so that it initiates an emergency braking of the industrial robot 1 when the determined positions of at least one of its axes A1-A6 differ by at least a predetermined value.

Although modifications and changes may be suggested by those skilled in the art, it is the intention of the inventors to embody within the patent warranted hereon all changes and modifications as reasonably and properly come within the scope of their contribution to the art.

We claim as our invention:

1. An industrial robot comprising:
a robot arm apparatus comprising at least one robot arm mounted on a base, said robot arm being movable with respect to each of a plurality of axes;
at least one of said axes having an electrical drive associated therewith for moving said robot arm relative to said at least one of said axes;
said electrical drive comprising a three-phase synchronous motor that drives said robot arm relative to said at least one of said axes, said electrical drive operating said three-phase synchronous motor based on electrical currents and electrical voltages generated by said electrical drive;
said electrical drive comprising a signal emitter that emits a first signal representing at least one of said electrical currents and said electrical voltages;
a position detector that emits a second signal representing the position of said at least one of said axes; and
a computerized control unit that operates said robot arm by controlling said electrical drive, said computerized control unit being supplied with said first signal from said signal emitter and said second signal from said position detector and being configured to determine a position of said at least one of said axes from said first and/or said second signals and to control said electrical drive dependent on said position.

2. An industrial robot as claimed in claim 1 wherein said computerized control unit is configured to determine said position as an angle position of said at least one of said axes.

3. An industrial robot as claimed in claim 1 wherein said electrical drive comprises a converter comprising an intermediate circuit that operates with an intermediate circuit electrical voltage, and wherein said signal emitter is configured to emit said signal as a signal selected from the group consisting of a signal representing at least one of said three-phase electrical voltages, a signal representing at least one of said three-phase electrical voltages, a signal representing at least one of said three-phase electrical currents, and a signal representing said intermediate circuit electrical voltage.

4. An industrial robot as claimed in claim 1 wherein said three-phase synchronous motor comprises a rotor, and wherein said position detector is an encoder that emits said second signal corresponding to an angle position of said rotor.

5. An industrial robot as claimed in claim 4 wherein said computerized control device is configured to stop operation of said robot arm if said first and second signals differ from each other by a predetermined amount.

6. An industrial robot as claimed in claim 4 wherein said encoder is a rotary encoder selected from the group consisting of a sin/cos sensor and an incremental sensor.

7. A method for operating an industrial robot comprising a robot arm apparatus comprising at least one robot arm mounted on a base, said robot arm being movable with respect to each of a plurality of axes, at least one of said axes having an electrical drive associated therewith that moves said robot arm with respect to said at least one of said axes, said method comprising the steps of:
via said electrical drive, using a three-phase synchronous motor to drive said robot arm with respect to said at least one of said axes, and with said electrical drive, operating said three-phase synchronous motor based on electrical currents and electrical voltages generated by said electrical drive;
from a signal emitter, emitting a first signal representing at least one of said electrical currents and said electrical voltages;
from a position detector, emitting a second signal representing the position of said at least one of said axes;
operating said robot arm from a computerized control unit by controlling said electrical drive, and supplying said computerized control unit with said first signal from said signal emitter said second signal from said position detector and, in said computerized control unit, determining a position of said at least one of said axes from said first and/or said second signals and controlling said electrical drive dependent on said position.

8. A method as claimed in claim 7 comprising, in said computerized control unit, determining said position as an angle position of said at least one of said axes.

9. A method as claimed in claim 7 wherein said electrical actuator comprises a converter comprising an intermediate circuit that operates with an intermediate circuit electrical voltage, and comprising emitting said signal from said signal emitter as a signal selected from the group consisting of a signal representing of said three-phase electrical voltages, a signal representing at least one of said three-phase electrical currents, and a signal representing said intermediate circuit electrical voltage.

10. A method as claimed in claim 7 wherein said three-phase synchronous motor comprises a rotor, and employing an encoder as said position detector that emits said second signal corresponding to an angle position of said rotor.

11. A method as claimed in claim 10 comprising, from said computerized control device, stopping operation of said robot arm if said first and second signals differ from each other by a predetermined amount.

12. A method as claimed in claim 10 comprising employing a rotary encoder as said encoder, and selecting said rotary encoder from the group consisting of a sin/cos sensor and an incremental sensor.
